(19) United States
(12) Patent Application Publication
(10) Pub. No.: US 2021/0212894 A1
(43) Pub. Date: Jul. 15, 2021

(54) FLEXIBLE MEDICAL CONTAINERS AND RELATED METHODS

(71) Applicant: Fresenius Medical Care Holdings, Inc., Waltham, MA (US)

(72) Inventors: Diego Suarez del Real Pena, Mission, TX (US); Juan Arturo Montecillo Juárez, Reynosa (MX); Irving Uziel Hernandez Gomez, Hidalgo, TX (US)

(73) Assignee: Fresenius Medical Care Holdings, Inc., Waltham, MA (US)

(21) Appl. No.: 16/744,011

(22) Filed: Jan. 15, 2020

(51) Int. Cl. A61J 1/14; A61J 1/10; B29C 65/02; B29C 65/00

(52) U.S. Cl. CPC A61J 1/1462; A61J 1/10; A61J 2205/20; B29C 65/02; B29C 66/43; A61J 1/1475

(57) ABSTRACT

The disclosed flexible medical containers may include a substantially transparent bag including a cavity sized and configured to contain a medical substance, at least one port in fluid communication with the cavity, and at least one hanger hole sized and shaped for suspending the flexible medical container from a hanger. The hanger hole may be at least partially surrounded by a colored material to provide visible contrast between the colored material and the hanger hole. In some disclosed examples, the flexible medical containers may include one or more digit holes adjacent to the hanger hole to facilitate lifting and holding the flexible medical containers. Various other flexible medical containers, systems, and methods are also disclosed.

### BACKGROUND

In the medical industry, fluids are often delivered intravenously to patients, such as to administer medications, hydrating fluids, nutritional products, therapeutic products, or blood-based products. Intravenous (“IV”) infusions typically involve using gravity to flow a fluid from an IV bag through a line into the vein of the patient. Conventionally, a venous catheter is positioned in fluid communication with the patient's vein via a hollow needle, and the line connects the IV bag to the venous catheter. The IV bag is usually suspended from a hanger located above the position of the venous catheter on the patient, such as on a pole, so that gravity can act on the fluid to properly deliver the fluid to the patient.

IV bags are usually made of a flexible polymer material, which is often transparent. In practice, a medical practitioner or the patient may lift the IV bag up, align one or more holes in the bag with the hanger, and pass the hanger end through the hole(s) in the IV bag to hang the IV bag from the hanger. Lines may be connected to the IV bag before or after suspending the IV bag from the hanger. This process may be repeated as IV bags are used and replaced.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a front perspective view of a flexible medical container, according to at least one embodiment of the present disclosure.

FIG. 2 is a front view of the flexible medical container of FIG. 1.

FIG. 3 is a front view of an upper portion of the flexible medical container of FIG. 1.

FIG. 4 is a back perspective view of the flexible medical container of FIG. 1.

FIG. 5 is a perspective view of an upper portion of a flexible medical container, according to at least one embodiment of the present disclosure.

FIG. 6 is a perspective view of a flexible medical container being suspended from a hanger by a user, according to at least one embodiment of the present disclosure.

FIG. 7 is a flow diagram illustrating an example method for forming a flexible medical container, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to flexible medical containers (e.g., IV bags, dialysis bags, etc.) and methods of forming flexible medical containers. As will be explained in further detail below, flexible medical containers according to some embodiments may include a colored material adjacent to a central hanger hole to provide visible contrast between the colored material and the hanger hole. Additionally or alternatively, the flexible medical containers may include at least one digit hole adjacent to the central hanger hole. The digit hole(s) may be sized and shaped for insertion of a user's digit (e.g., finger and/or thumb) to facilitate carrying and suspending the flexible medical container. Accordingly, embodiments of the present disclosure may facilitate suspending flexible medical containers from a hanger by facilitating the aligning of hanger holes with hangers and/or by making it easier for a user to grip and hold the flexible medical containers.

Features from any of the embodiments described herein may be used in combination with one another in accordance with the general principles described herein. These and other embodiments, features, and advantages will be more fully understood upon reading the following detailed description in conjunction with the accompanying drawings and appended claims.

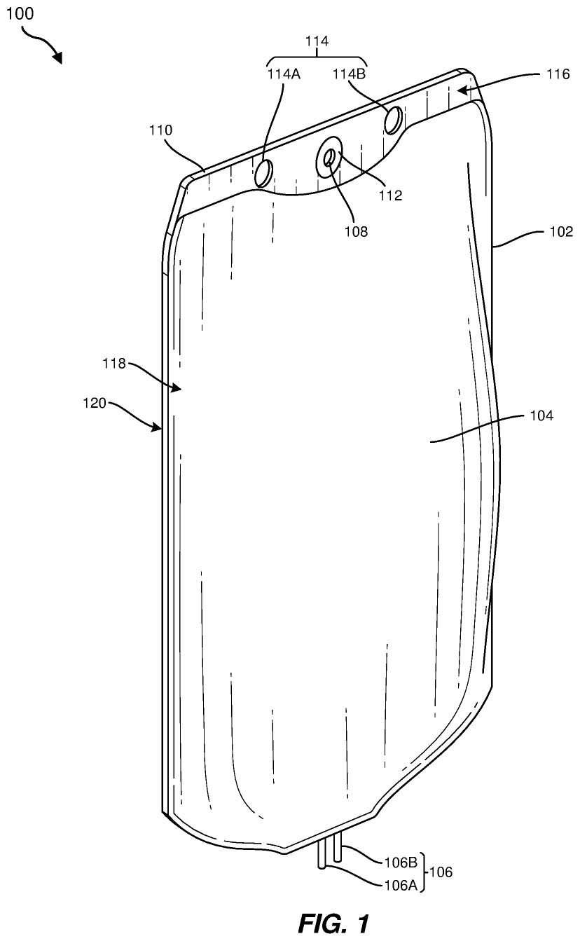

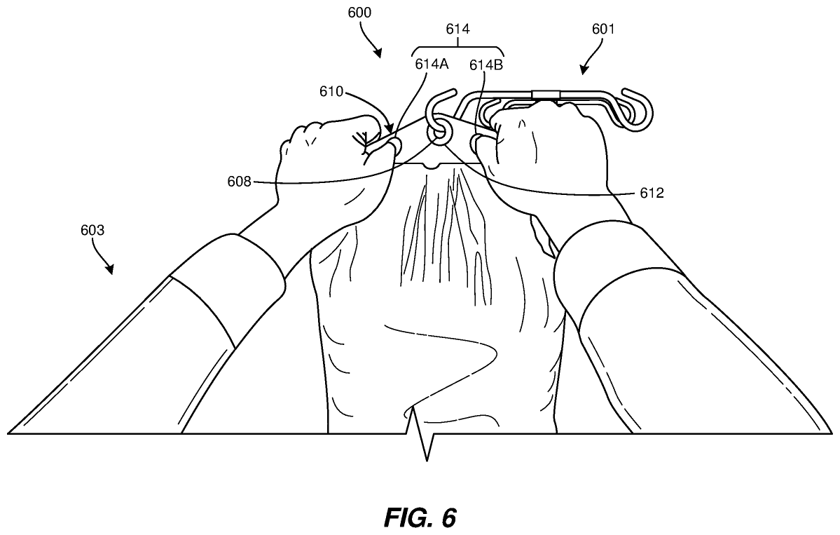

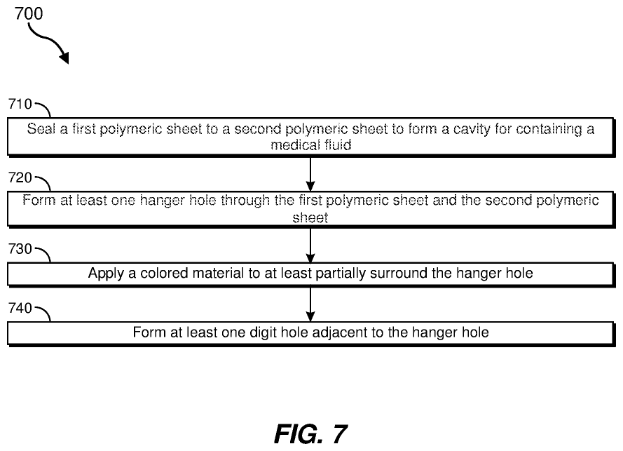

The following will provide, with reference to FIGS. 1-5, detailed descriptions of flexible medical containers according to embodiments of the present disclosure. With reference to FIG. 6, the following will provide detailed descriptions of how such flexible medical containers may be suspended on a hanger. With reference to FIG. 7, the following will provide detailed descriptions of example methods for fabricating flexible medical containers.

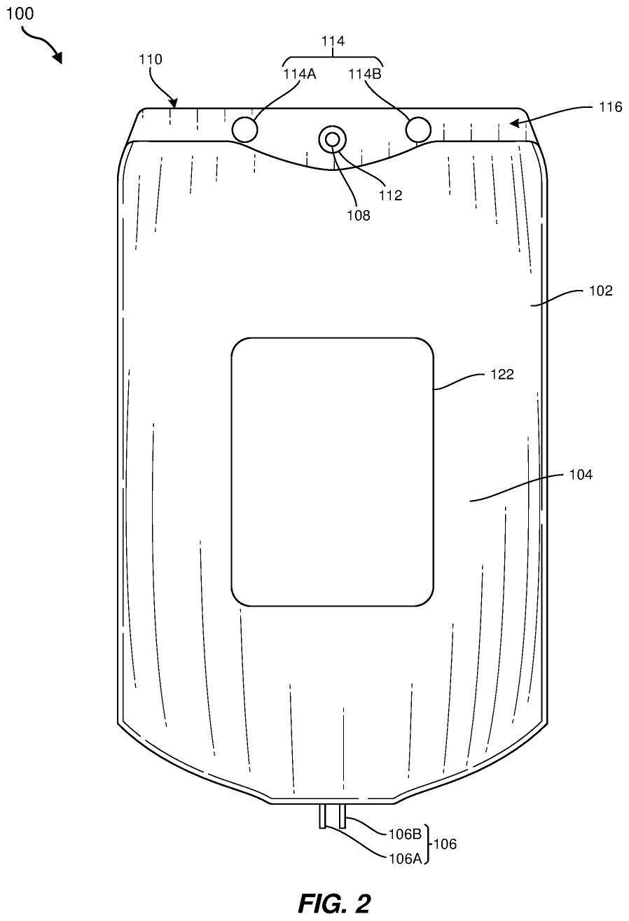

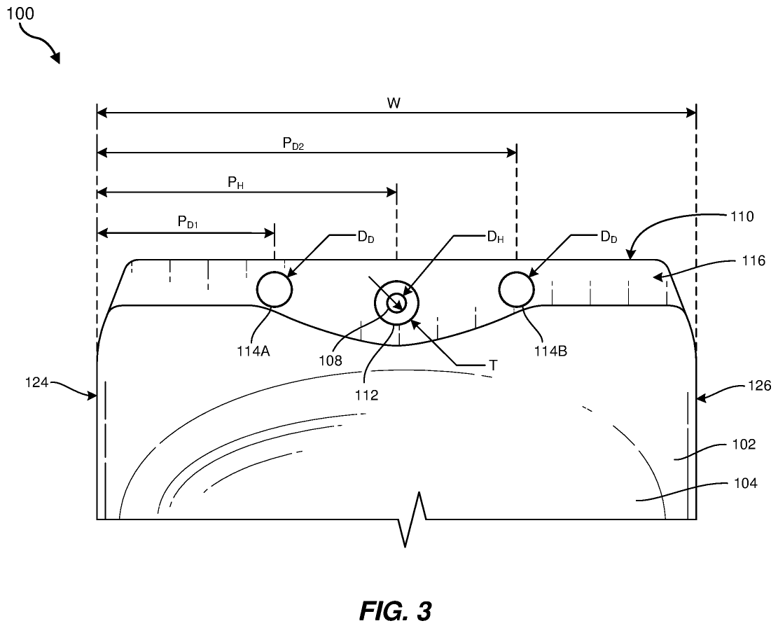

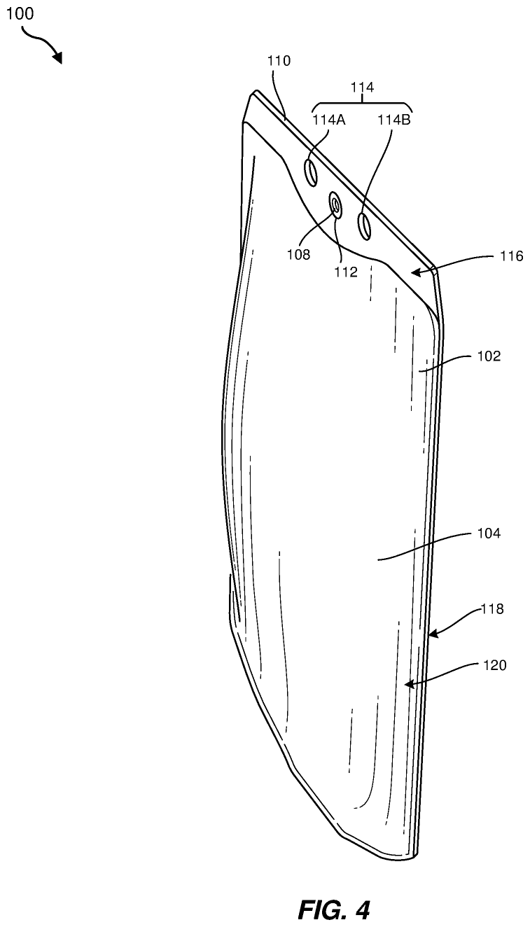

FIG. 1 is a front perspective view of a flexible medical container 100 (e.g., an IV bag), according to at least one embodiment of the present disclosure. FIG. 2 is a front view of the flexible medical container 100 of FIG. 1. FIG. 3 is a front view of an upper portion of the flexible medical container 100 of FIG. 1. FIG. 4 is a back perspective view of the flexible medical container 100 of FIG. 1.

As illustrated in FIGS. 1-4, the flexible medical container 100 may include a substantially transparent bag 102 including a cavity 104 sized and configured to contain a medical substance, such as a fluid for intravenous administration to a patient. The flexible medical container 100 may also include at least one port 106 (e.g., an inlet port 106A and an outlet port 106B) in fluid communication with the cavity 104. At least one hanger hole 108 may be located near an upper edge 110 of the bag 102. For example, the flexible medical container 100 may include a single hanger hole 108 that is centrally located near the upper edge 110 of the bag 102. In some embodiments, the hanger hole 108 may be at least partially surrounded by a colored material 112 to provide visible contrast between the colored material 112 and the hanger hole 108. In some embodiments, at least one digit hole 114 (e.g., a first digit hole 114A and a second digit hole 114B) may be located adjacent to the hanger hole 108.

In some examples, the term “substantially” in reference to a given parameter, property, or condition may mean and include to a degree that one of ordinary skill in the art would understand that the given parameter, property, or condition is met within a small degree of variance, such as within acceptable manufacturing tolerances. By way of example, depending on the particular parameter, property, or condition that is substantially met, the parameter, property, or condition may be at least 90% met, at least 95% met, or even at least 99% met. In some examples, relational terms, such as “first,” “second,” “bottom,” “upper,” “above,” “front,” “back,” “left,” “right,” etc., may be used for clarity and convenience in understanding the disclosure and accompanying drawings and may not necessarily connote or depend on any specific preference, orientation, or order, except where the context clearly indicates otherwise. In the case of the bag 102, directional terms, such as “bottom,” “upper,” “above,” “right,” “left,” etc., may generally refer to directions relative to the bag 102 when suspended by the hanger hole 108 during use. In some examples, the term “surround” and related terms may refer to visually surrounding (e.g., circumscribing) a feature that is viewed, and does not necessarily mean surrounding in all physical dimensions.

The cavity 104 of the bag 102 may be configured to contain a solution including a medication, a hydrating fluid, a dialysis solution, a nutritional product, a therapeutic product, or a blood-based product for administration to the patient. In some cases, where appropriate, the configuration of the bag with respect to size, shape, ports, and other general features may be adapted to the particular function of the solution so administered. Thus, the bag 102 may be formed of a material that is sterile and non-reactive to such solutions. By way of example and not limitation, the bag 102 may be formed of a substantially transparent polymeric material, such as polyvinyl chloride (“PVC”), polypropylene, ethylene vinyl acetate, copolyester ether, etc.

The inlet port 106A may be used for introducing into the cavity 104 the fluid to be intravenously administered to the patient. The inlet port 106A may also be configured for injecting a substance (e.g., a medication) into the cavity 104. The outlet port 106B may be configured for administering the fluid to the patient, such as through a line and a venous catheter connected to the outlet port 106B. At least the outlet port 106B may be positioned at or near a bottom edge of the flexible medical container 100, such that gravity may be used to force fluid from the cavity 104 into and through the outlet port 106B. Other conventional components may also be employed to facilitate administration of the fluid from the cavity 104 to the patient, such as a drip chamber, a back check valve, a slider clamp, a roller clamp, one or more additional ports (e.g., an administration port, a sampling port, etc.), a luer lock, a Y-connector, etc.

The hanger hole 108 may extend through the material forming the bag 102. In some examples, the hanger hole 108 may be positioned in an upper sealed region 116 of the bag 102. For example, as explained below with reference to FIG. 4, the bag 102 may be formed of a front bag material 118 and a back bag material 120 that are sealed to each other to form the cavity 104. The upper sealed region 116 may include an area above the cavity 104 and along the upper edge 110 of the bag 102, across which the front bag material 118 and the back bag material 120 are sealed to each other. In some examples, a reinforcement material in addition to the front bag material 118 and the back bag material 120 may be included in the upper sealed region 116. The colored material 112 may be applied to (e.g., adhered to, printed on, infused into, etc.) the front bag material 118, applied to the back bag material 120, positioned between the front bag material 118 and the back bag material 120, or integrated into the front bag material 118 and/or the back bag material 120. The hanger hole 108 may be circular, oval, triangular, rectangular, elongated, or any other suitable shape for being positioned on a corresponding hanger.

As shown in FIGS. 1-4, the colored material 112 may, in some embodiments, fully surround the hanger hole 108 in the shape of an annulus. In additional embodiments, the colored material 112 may have a different configuration, such as only partially surrounding the hanger hole 108. For example, the colored material 112 may be positioned in one or more sections adjacent to the hanger hole 108, such as along a bottom edge of the hanger hole 108, along an upper edge of the hanger hole 108, along a left edge of the hanger hole 108, along a right edge of the hanger hole 108, or any combination thereof. In addition, the colored material 112 may have a different shape than annular, such as triangular, rectangular, oval, elongated, one or more arrows pointing at the hanger hole 108, combinations thereof, etc. The colored material 112 may be opaque, or the colored material at least partially transparent to visible light. The colored material 112 may be or include a variety of colors. For example, the colored material 112 may be or include white, black, red, orange, yellow, green, blue, purple, brown, metallic, or any other suitable color that may provide visible contrast between the colored material 112 and the hanger hole 108 and/or the material of the bag 102.

Referring to FIG. 2, the flexible medical container 100 may include a label 122 applied to (e.g., printed on, adhered to) the bag 102 (e.g., to the front bag material 118 and/or to the back bag material 120). The label 122 may include information about the bag 102 and/or about the medical substance (e.g., fluid, medication, etc.) contained in the cavity 104 of the bag. For example, the label 122 may identify the type and concentration of a solution in the cavity 104. Warnings, instructions, and/or other information may also be included on the label 122. In some embodiments, the label 122 may be printed or otherwise applied (e.g., stamped, screen-printed, inkjet printed, stenciled, etc.) directly on a surface of the bag 102. The colored material 112 may also be printed or otherwise applied directly on the surface of the bag 102 adjacent to the hanger hole 108. In some examples, the colored material 112 and the material forming the label 122 may be the same material, which may be applied to the bag 102 at the same time. The colored material 112 may be color-coded to the medical substance contained within the cavity 104. For example, a bag 102 containing a first medical substance may have a colored material 112 exhibiting a first color and a bag 102 containing a second, different medical substance (or concentration thereof) may have a colored material 112 exhibiting a second, different color.

In additional embodiments, the colored material 112 may be or include a solid insert that is coupled to the bag 102. For example, the insert may be adhered to an outer surface of the bag 102 (e.g., on an outer surface of the front bag material 118 or of the back bag material 120), positioned within a cavity formed in the bag 102, or positioned between the front bag material 118 and the back bag material 120. The insert may be opaque or at least partially transparent to visible light.

In some embodiments, the colored material 112 may be or include a dye integrated into the material of the bag 102 adjacent to the hanger hole 108. For example, during or after formation of the material of the bag 102, a dye may be selectively infused into the material of the bag 102 to be in the appropriate position adjacent to the hanger hole 108. By way of example and not limitation, the infusion of the dye may occur through heat-treating the portion of the bag 102 adjacent to the hanger hole 108 in the presence of a dye source.

In some examples, the colored material 112 may be or include paint. For example, paint may be applied with a suitable paint applicator (e.g., a brush, a sponge, through a stencil, etc.) to a surface of the bag 102.

The hanger hole 108 may be formed (e.g., punched, cut, melted, etc.) through the material of the bag 102 prior to or after the colored material 112 is applied to the bag 102. For example, the hanger hole 108 may be formed in the bag 102, after which the colored material 112 is applied to the bag 102 adjacent to the hanger hole 108. In additional examples, the colored material 112 may be applied to the bag 102, and the hanger hole 108 may then be formed through the material of the bag 102. The hanger hole 108 may also be formed through the pre-applied colored material 112, such as by simultaneously punching or otherwise cutting through the colored material 112 and through the material of the bag 102.

Although FIGS. 1-4 illustrate an embodiment in which the flexible medical container 100 includes a single, centrally located hanger hole 108, the present disclosure is not so limited. In additional embodiments, the flexible medical container 100 may include two or more hanger holes 108, such as to suspend the flexible medical container 100 from a hanger system that includes two or more respective hangers. Each of the hanger holes 108 may include a respective colored material 112 adjacent thereto (e.g., at least partially surrounding the hanger hole 108).

Each of the digit holes 114 may be sized and shaped for receiving at least a portion of a user's digit (e.g., a thumb or another finger) for carrying the flexible medical container 100 and positioning the hanger hole 108 on a respective hanger to suspend the flexible medical container 100. Thus, in some examples, each of the digit holes 114 may have a larger diameter than the hanger hole 108 to accommodate the user's digit. Referring to FIG. 3, the hanger hole 108 may have a hanger hole diameter D_{H} and each of the digit holes 114A, 114B may have a digit hole diameter D_{D} that is larger than the hanger hole diameter D_{H}. By way of example and not limitation, the hanger hole diameter D_{H} may be between about 0.3 inch and about 0.4 inch and the digit hole diameter D_{D} may be between about 0.5 inch and about 0.8 inch, such as about 0.58 inch. A radial thickness T of the colored material 112 around the hanger hole 108 may be at least about 0.25 inch, such as between about 0.25 inch and about 0.75 inch.

In some examples, the term “diameter” may refer to a smallest dimension across a shape. For example, if the hanger hole 108 and/or the digit holes 114 are not circular, the corresponding diameter thereof may be a smallest dimension passing across a geometric center of the corresponding hanger hole 108 or digit hole 114.

Still referring to FIG. 3, the flexible medical container 100 may have a lateral width W between a first lateral edge 124 and a second, opposite lateral edge 126. In some embodiments, the respective positions of the first digit hole 114A, hanger hole 108, and second digit hole 114B may be relative to the lateral width W of the flexible medical container 100. For example, the first digit hole position P_{D1} may be between about 0.25 to about 0.4 of the lateral width W from the first lateral edge 124, such as about one third of the lateral width W from the first lateral edge 124. In embodiments in which the flexible medical container 100 includes a single hanger hole 108, the hanger hole 108 may be substantially centrally located in the flexible medical container 100. Thus, the hanger hole position P_{H} may be about 0.5 of the lateral width W from the first lateral edge 124. The second digit hole position P_{D2} may be between about 0.6 to about 0.75 of the lateral width W from the first lateral edge 124, such as about two-thirds of the lateral width W from the first lateral edge 124. In other words, the second digit hole 114B may be positioned between about 0.25 to about 0.4 of the lateral width W from the second lateral edge 126. The first digit hole 114A and the second digit hole 114B may be positioned on respectively opposite sides of the hanger hole 108. In some embodiments, as illustrated in FIGS. 1-4, the digit holes 114 may be positioned slightly above (e.g., closer to the upper edge 110 than) the hanger hole 108.

As shown in the front perspective view of FIG. 1 and the rear perspective view of FIG. 4, the colored material 112 may be visible from the front of the flexible medical container 100 and from the back of the flexible medical container 100. As noted above, in some embodiments, the colored material 112 may be applied to the front bag material 118, to the back bag material 120, between the front bag material 118 and the back bag material 120, integrated in the material of the bag 102, and/or to both the front bag material 118 and the back bag material 120. In some embodiments, the flexible medical container 100 may be substantially symmetrical in shape between the front and the back, such that the flexible medical container 100 may be suspended by insertion of a hanger from the front or from the back. In either case, the user may visually identify and view the hanger hole 108 using the colored material 112 to facilitate placing the hanger hole 108 over a corresponding hanger to suspend the flexible medical container 100.

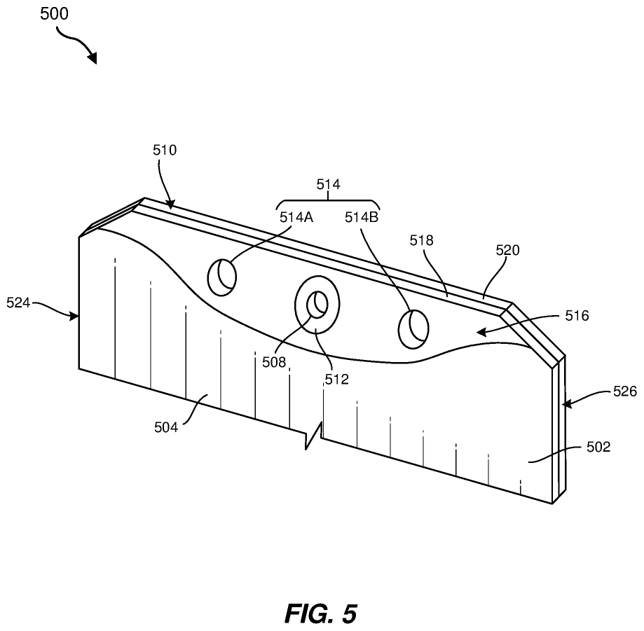

FIG. 5 is a perspective view of an upper portion of a flexible medical container 500, according to at least one embodiment of the present disclosure. The flexible medical container 500 illustrated in FIG. 5 may be similar to the flexible medical container 100 described above and shown in FIGS. 1-4. For example, the flexible medical container 500 may include a bag 502 defined by a front bag material 518 and a back bag material 520, a cavity 504 in the bag 502 for containing a medical substance (e.g., a fluid) for delivery to a patient, at least one hanger hole 508 positioned near an upper edge 510 of the bag 502, a colored material 512 at least partially surrounding the hanger hole 508, at least one digit hole 514 (e.g., a first digit hole 514A and a second digit hole 514B) positioned adjacent to the hanger hole 508, a first lateral edge 524 of the bag 502, and a second, opposite lateral edge 526 of the bag 502. The hanger hole 508 and the digit holes 514 may pass through an upper sealed region 516 of the bag 502.

As illustrated in FIG. 5, the bag 502 and cavity 504 may be formed by sealing the front bag material 518 to the back bag material 520. For example, the front bag material 518 and the back bag material 520 may be sealed to each other across an area of the upper sealed region 516, along the first lateral edge 524, along the second lateral edge 526, and along a bottom edge (not shown in the view of FIG. 5) of the bag 502. In some embodiments, the sealing may be accomplished by selectively heat-treating the material of the bag 502 in the locations and regions to be sealed. For example, portions of the front bag material 518 and the back bag material 520 to be sealed to each other may be pressed together with a hot press, which may bond (e.g., melt) the front bag material 518 to the back bag material 520. In some embodiments, the material in the sealed portions may be sufficiently bonded and commingled to form a single, integral material at an interface between the front bag material 518 and the back bag material 520. In additional embodiments, the front bag material 518 and the back bag material 520 may remain distinguishable in the sealed portions after sealing is complete. For example, an adhesive material may be positioned between the front bag material 518 and the back bag material 520 to facilitate sealing of the materials to each other to form the bag 502.

As noted above, in some embodiments the colored material 512 may include an insert that may be positioned between the front bag material 518 and the back bag material 520 prior to forming the upper sealed region 516. In additional embodiments, the colored material 512 may be applied to an outer surface of the front bag material 518 and/or to an outer surface of the back bag material 520 prior to or after the sealing is completed.

FIG. 6 is a perspective view of a flexible medical container 600 being suspended from a hanger 601 by a user 603 (e.g., a medical professional, a patient, or a caregiver), according to at least one embodiment of the present disclosure. The flexible medical container 600 may be the same as or similar to any of the flexible medical containers 100, 500 described above. As illustrated in FIG. 6, the user 603 may lift the flexible medical container 600 by passing one or more digits (e.g., thumbs) through corresponding digit holes 614A, 614B (collectively referred to as “digit holes 614”) passing through the flexible medical container 600 near an upper edge 610 thereof. The digit holes 614 may facilitate lifting the flexible medical container 600, such as by reducing or eliminating a need for the user 603 to squeeze the flexible medical container 600 between fingers and/or between one or more fingers and respective palms, which might otherwise require significant hand strength depending on a weight of a medical substance contained within the flexible medical container 600.

After passing at least one digit through the digit hole(s) 614, the user 603 may lift the flexible medical container 600 to align at least one hanger hole 608 passing through the flexible medical container 600 with the corresponding hanger 601. The user 603 may view a colored material 612 surrounding the hanger hole 608 to facilitate the alignment of the hanger hole 608 with the hanger 601. A conventional flexible medical container that lacks the colored material 612 may be difficult to visually align with a hanger since the hanger hole may be visibly similar to (and difficult to distinguish from) the surrounding substantially transparent material of the flexible medical container. Thus, users may conventionally align the hanger hole with the hanger by feel, moving the flexible medical container (which is sometimes full of a medical substance and held up as high or higher than the user's head) back and forth until the hanger end passes through the hanger hole. On the other hand, the colored material 612 of the flexible medical container 600 of the present disclosure may facilitate aligning the hanger hole 608 with the hanger 601 by providing visible contrast between the hanger hole 608 and the portion of the flexible medical container 600 adjacent to the hanger hole 608.

FIG. 7 is a flow diagram illustrating a method 700 for forming a flexible medical container. At operation 710, a first polymeric sheet may be sealed to a second polymeric sheet to form a cavity for containing a medical fluid therebetween. Operation 710 may be performed in a variety of ways. For example, the first polymeric sheet and the second polymeric sheet may include a polymeric material suitable for medical use, such as PVC, polypropylene, ethylene vinyl acetate, copolyester ether, etc. The first and second polymeric sheets may be substantially transparent. The sealing may be selectively performed along at least a portion of peripheries of the first polymeric sheet and of the second polymeric sheet. The sealing may be accomplished by heat-treating the portions to be sealed and/or by adhering the portions to be sealed. In some examples, an upper sealed region may be formed by sealing the first polymeric sheet to the second polymeric sheet across an area near an upper edge of the flexible medical container to be formed.

At operation 720, at least one hanger hole may be formed through the first polymeric sheet and the second polymeric sheet. Operation 720 may be performed in a variety of ways. For example, the hanger hole may be punched, cut, melted, or otherwise formed through the first and second polymeric sheets. In some embodiments, the hanger hole may be formed in a central location near an upper edge of the flexible medical container, such as in the upper sealed region.

At operation 730, a colored material may be applied to the first polymeric sheet and/or to the second polymeric sheet to at least partially surround the hanger hole. Operation 730 may be performed in a variety of ways. For example, the colored material may be printed or painted on a surface of the first polymeric sheet and/or the second polymeric sheet. In additional examples, a dye may be applied to the first polymeric sheet and/or to the second polymeric sheet. In further examples, at least one colored solid insert may be coupled to the first polymeric sheet and/or to the second polymeric sheet. The colored material may be opaque or at least partially transparent to visible light. In each of these examples, the colored material may provide a visible contrast between the hanger hole and the material at least partially surrounding the hanger hole.

At operation 740, at least one digit hole may be formed adjacent to the hanger hole. Operation 740 may be performed in a variety of ways. For example, a first digit hole may be formed on a first side of the hanger hole and a second digit hole may be formed on a second, opposite side of the hanger hole. The first digit hole may be formed to be located between about 0.25 to about 0.4 of the width of the flexible medical container to be formed from a first lateral edge of the flexible medical container, and the second digit hole may be formed to be located between about 0.25 to about 0.4 of the width from a second lateral edge of the flexible medical container. Each of the digit holes may be formed to have a larger diameter than the hanger hole, such as for inserting a digit (e.g., a thumb or a finger) of a user holding the flexible medical container. For example, each of the digit holes may have a diameter in the range of about 0.58 inch to about 0.8 inch. The digit holes may be formed by punching, cutting, and/or melting the first polymeric material and the second polymeric material.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. For example, the application of the colored material in operation 730 may be performed prior to the sealing of operation 710, prior to forming the hanger hole of operation 720, and/or after forming the digit hole(s) of operation 740. The various example methods described and/or illustrated herein may also omit one or more of the steps described or illustrated herein or include additional steps in addition to those disclosed.

Accordingly, the present disclosure includes flexible medical containers and associated methods that may provide one or more improvements over conventional flexible medical containers. For example, the flexible medical containers may include a colored material at least partially surrounding a hanger hole for providing visible contrast between the hanger hole and the surrounding material. Flexible medical containers of the present disclosure may alternatively or additionally include at least one digit hole sized and shaped for inserting a user's digit (e.g., thumb, finger) for holding the flexible medical container. These and other features may facilitate the act of suspending flexible medical containers from hangers, as explained above.

The following example embodiments are also included in the present disclosure.

Example 1: A flexible medical container, which may include: a substantially transparent bag including a cavity sized and configured to contain a medical substance; at least one port in fluid communication with the cavity; and at least one hanger hole sized and shaped for suspending the flexible medical container from a hanger, wherein the hanger hole is at least partially surrounded by a colored material to provide visible contrast between the colored material and the hanger hole.

Example 2: The flexible medical container of Example 1, wherein the colored material fully surrounds the hanger hole.

Example 3: The flexible medical container of Example 1 or Example 2, wherein the hanger hole is centrally located near an upper edge of the substantially transparent bag.

Example 4: The flexible medical container of any of Examples 1 through 3, wherein the substantially transparent bag is configured to contain a fluid for intravenous delivery to a patient.

Example 5: The flexible medical container of any of Examples 1 through 4, further including at least one digit hole positioned adjacent to the hanger hole, wherein the digit hole is sized and shaped for receiving at least a portion of a user's digit to carry the flexible medical container.

Example 6: The flexible medical container of Example 5, wherein the at least one digit hole has a diameter larger than the hanger hole.

Example 7: The flexible medical container of any of Examples 1 through 6, wherein the hanger hole has a diameter in the range of about 0.3 inch to about 0.4 inch.

Example 8: The flexible medical container of any of Examples 1 through 7, wherein the hanger hole has a circular shape.

Example 9: The flexible medical container of any of Examples 1 through 8, wherein the colored material includes at least one of: paint; printed material; or a solid insert.

Example 10: The flexible medical container of any of Examples 1 through 9, wherein the colored material includes an opaque colored material.

Example 11: The flexible medical container of any of Examples 1 through 10, wherein the colored material includes an annulus with a radial thickness of at least about 0.25 inch.

Example 12: A flexible medical container, which may include: a bag including a cavity sized and configured to contain a medical substance; at least one port in fluid communication with the cavity; at least one hanger hole sized and shaped for suspending the flexible medical container from a hanger; and two digit holes adjacent to the hanger hole, wherein each of the two digit holes is sized and shaped for inserting a user's digit to carry the flexible medical container.

Example 13: The flexible medical container of Example 12, wherein the two digit holes include a first digit hole on a first lateral side of the hanger hole and a second digit hole on a second, opposite lateral side of the hanger hole.

Example 14: The flexible medical container of Example 13, wherein the bag has a width from a first lateral edge to a second lateral edge, wherein the first digit hole is located between about 0.25 to about 0.4 of the width from the first lateral edge and the second digit hole is located between about 0.25 to about 0.4 of the width from the second lateral edge.

Example 15: The flexible medical container of any of Examples 12 through 14, wherein each of the two digit holes has a diameter within the range of about 0.58 inch to about 0.8 inch.

Example 16: The flexible medical container of any of Examples 12 through 15, which may further include a colored material surrounding the hanger hole.

Example 17: A method of fabricating a flexible medical container, which may include: sealing a first polymeric sheet to a second polymeric sheet along at least a portion of their peripheries to form a cavity for containing a medical fluid between the first polymeric sheet and the second polymeric sheet; forming at least one hanger hole through the first polymeric sheet and the second polymeric sheet, wherein the hanger hole is sized and shaped for suspending the flexible medical container from a hanger; applying a colored material to at least partially surround the hanger hole; and forming at least one digit hole adjacent to the hanger hole, wherein the digit hole is sized and shaped for inserting a user's digit to carry the flexible medical container.

Example 18: The method of Example 17, wherein sealing the first polymeric sheet to the second polymeric sheet includes sealing two substantially transparent polymeric sheets to each other.

Example 19: The method of Example 17 or Example 18, wherein applying the colored material to at least partially surround the hanger hole includes printing the colored material on a surface of at least one of the first polymeric sheet or the second polymeric sheet.

Example 20: The method of any of Examples 17 through 19, wherein forming the at least one digit hole includes forming two digit holes, wherein each digit hole has a diameter in the range of about 0.58 inch to about 0.8 inch.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A flexible medical container, comprising:
a substantially transparent bag including a cavity sized and configured to contain a medical substance;
at least one port in fluid communication with the cavity; and
at least one hanger hole sized and shaped for suspending the flexible medical container from a hanger, wherein the hanger hole is at least partially surrounded by a colored material to provide visible contrast between the colored material and the hanger hole.

2. The flexible medical container of claim 1, wherein the colored material fully surrounds the hanger hole.

3. The flexible medical container of claim 1, wherein the hanger hole is centrally located near an upper edge of the substantially transparent bag.

4. The flexible medical container of claim 1, wherein the substantially transparent bag is configured to contain a fluid for intravenous delivery to a patient.

5. The flexible medical container of claim 1, further comprising at least one digit hole positioned adjacent to the hanger hole, wherein the digit hole is sized and shaped for receiving at least a portion of a user's digit to carry the flexible medical container.

6. The flexible medical container of claim 5, wherein the at least one digit hole has a diameter larger than the hanger hole.

7. The flexible medical container of claim 1, wherein the hanger hole has a diameter in the range of about 0.3 inch to about 0.4 inch.

8. The flexible medical container of claim 1, wherein the hanger hole has a circular shape.

9. The flexible medical container of claim 1, wherein the colored material comprises at least one of:
paint;
printed material; or
a solid insert.

10. The flexible medical container of claim 1, wherein the colored material comprises an opaque colored material.

11. The flexible medical container of claim 1, wherein the colored material comprises an annulus with a radial thickness of at least about 0.25 inch.

12. A flexible medical container, comprising:
a bag including a cavity sized and configured to contain a medical substance;
at least one port in fluid communication with the cavity;
at least one hanger hole sized and shaped for suspending the flexible medical container from a hanger; and
two digit holes adjacent to the hanger hole, wherein each of the two digit holes is sized and shaped for inserting a user's digit to carry the flexible medical container.

13. The flexible medical container of claim 12, wherein the two digit holes comprise a first digit hole on a first lateral side of the hanger hole and a second digit hole on a second, opposite lateral side of the hanger hole.

14. The flexible medical container of claim 13, wherein the bag has a width from a first lateral edge to a second lateral edge, wherein the first digit hole is located between about 0.25 to about 0.4 of the width from the first lateral edge and the second digit hole is located between about 0.25 to about 0.4 of the width from the second lateral edge.

15. The flexible medical container of claim 12, wherein each of the two digit holes has a diameter within the range of about 0.58 inch to about 0.8 inch.

16. The flexible medical container of claim 12, further comprising a colored material surrounding the hanger hole.

17. A method of fabricating a flexible medical container, the method comprising:
sealing a first polymeric sheet to a second polymeric sheet along at least a portion of their peripheries to form a cavity for containing a medical fluid between the first polymeric sheet and the second polymeric sheet;
forming at least one hanger hole through the first polymeric sheet and the second polymeric sheet, wherein the hanger hole is sized and shaped for suspending the flexible medical container from a hanger;
applying a colored material to at least partially surround the hanger hole; and
forming at least one digit hole adjacent to the hanger hole, wherein the digit hole is sized and shaped for inserting a user's digit to carry the flexible medical container.

18. The method of claim 17, wherein sealing the first polymeric sheet to the second polymeric sheet comprises sealing two substantially transparent polymeric sheets to each other.

19. The method of claim 17, wherein applying the colored material to at least partially surround the hanger hole comprises printing the colored material on a surface of at least one of the first polymeric sheet or the second polymeric sheet.

20. The method of claim 17, wherein forming the at least one digit hole comprises forming two digit holes, wherein each digit hole has a diameter in the range of about 0.58 inch to about 0.8 inch.
